(19) United States
(12) Patent Application Publication
(10) Pub. No.: US 2004/0054535 A1
(43) Pub. Date: Mar. 18, 2004

(54) System and method of processing structured text for text-to-speech synthesis

(76) Inventors: Andrew William Mackie, Los Gatos, CA (US); Harry Martin Bliss, Evanston, IL (US)

Correspondence Address: MOTOROLA INC, 600 NORTH US HIGHWAY 45, LIBERTYVILLE, IL, 60048-5343, US

(21) Appl. No.: 09/986,217

(22) Filed: Oct. 22, 2001

(51) Int. Cl. G10L 13/00

(52) U.S. Cl. 704/260

(57) ABSTRACT

A method for processing structured text is provided. Tokenized text is created from structured text in accordance with a predetermined set of tokenizer rules set forth in a token pattern knowledge base (13), in which each tokenizer rule defines a simplex constituent. Parsed text is created from tokenized text in accordance with a predetermined set of parser rules set forth in a parser rule knowledge base (15), in which each parser rule defines a complex constituent. Processed text is created from parsed text in accordance with a predetermined set of interpreter rules set forth in an interpretation knowledge base (17), in which each interpreter rule defines a message element corresponding to a simplex or complex constituent, whereby the processed text identifies and provides an interpretation of the message elements of the corresponding structured text for a useful purpose, such as text-to-speech synthesis.

### FIELD OF THE INVENTION

This invention generally relates to the field of structured text processing and, more particularly, to a system and method of processing structured text for text-to-speech synthesis.

### BACKGROUND OF THE INVENTION

Text-to-speech (TTS) synthesizers are commonly used to convert text into speech. Difficulties can arise, however, when these synthesizers attempt to convert structured text such as, for example, e-mail messages into speech. This is because such text differs in crucial ways from the “typical” input for which these TTS synthesizers were designed. For example, an e-mail message is likely to include substantial amounts of text concerned with the sending and receiving of the message. Such text should typically not be converted into speech. Additionally, the correct identification of the large-scale features of the e-mail message (such as headers, embedded messages, signature blocks, etc.) can require the analysis of spans of text that are longer than the spans of text typically passed to the TTS synthesizer for real-time processing.

Attempts have been made to provide e-mail preprocessors that can recognize and interpret the specific features of e-mail messages and transform them into a format that can be input into a specific TTS synthesizer. However, existing e-mail preprocessors do not always process their inputs in a reliable or perspicuous manner. This is because the finite-state pattern matching techniques typically used by such preprocessors are not powerful enough to reliably identify all elements of an e-mail message. However, unless all of these elements are identified, the e-mail message is unlikely to be properly converted from text into speech. In particular, the misidentification of elements in the e-mail message's header is likely to result in the TTS synthesizer erroneously attempting to interpret arbitrary strings of characters as “normal” English text to be converted into speech.

In addition to the above, existing preprocessors are typically designed to process only one type of structured text, namely e-mail messages. Because of this specificity, they cannot be easily adapted to process other types of structured text including, for example, weather reports, financial transactions, news reports, and web text.

Accordingly, it would desirable to have a system and method that overcomes the disadvantages described above.

### BRIEF DESCRIPTION OF THE DRAWINGS

FIG. 1 is a block diagram of one embodiment of a system for processing structured text in accordance with the present invention;

FIG. 2 is a flowchart which illustrates a routine that carries out a tokenization function;

FIG. 3 is a flowchart which illustrates a routine that carries out a parsing function;

FIG. 4 is a flowchart which illustrates a routine that carries out an interpreting function;

FIG. 5 is an example of a parsed text expressed as a tree;

FIG. 6 is a flowchart which illustrates a routine that carries out an interpretation of a single node;

FIG. 7 illustrates an example of a token pattern table;

FIG. 8 illustrates an example of a parser table;

FIG. 9 illustrates an example of an interpreter table;

FIG. 10 is a Unified Modeling Language (UML) diagram for the embodiment of FIG. 1;

FIG. 11 illustrates an example of the text of an e-mail message;

FIG. 12A illustrates the tokenized text of the e-mail message, i.e., after it has been processed by the tokenizer;

FIG. 12B illustrates a trace of a parse generated by the parser after it receives the tokenized text of the e-mail message from the tokenizer;

FIG. 13 illustrates the parsed text of the e-mail message (i.e. after it has been processed by the tokenizer and the parser);

FIG. 14A illustrates the plain text of the e-mail message after it has been interpreted by the interpreter in PLAIN mode; and

FIG. 14B illustrates the tagged text of the e-mail message after it has been interpreted by the interpreter in TAG mode.

### DETAILED DESCRIPTION OF THE PREFERRED EMBODIMENTS

The present invention provides a method of processing a structured text to result in a processed text whereby the processed text identifies and provides an interpretation of message elements of the corresponding structured text for a useful purpose such as text-to-speech synthesis. A token pattern knowledge base, a parser rule knowledge base, and an interpretation knowledge base are provided.

The token pattern knowledge base includes a predetermined set of tokenizer rules in which each tokenizer rule defines a simplex constituent according to a predetermined token pattern. The token pattern can be a line pattern, in which case the entire line of text will be interpreted as exactly one token in the corresponding simplex constituent. Alternatively, the token pattern can be a start line keyword pattern, in which case the entire line of text will be interpreted as at least one token in the corresponding simplex constituent. Alternatively, the token pattern can be a word pattern, in which case the matched word is interpreted as a single token in the corresponding simplex constituent. Thus, the simplex constituent spans a sequence of at least one token in the tokenized text. The first token of the simplex constituent is identified by a start marker, and the last token of the simplex constituent is identified by an end marker. In the case that the simplex constituent spans exactly one token, the start marker and the end marker are applied to the same token.

The parser rule knowledge base includes a predetermined set of parser rules in which each parser rule defines a complex constituent according to a predetermined pattern of tokens and/or simplex constituents and/or complex constituents. Thus, the complex constituent spans a sequence of at least one token in the tokenized text. The first token of the complex constituent is identified by a start label, and the last token of the complex constituent is identified by an end label. In the case that the complex constituent spans exactly one token, the start label and the end label are applied to the same token.

The interpretation knowledge base includes a predetermined set of interpreter rules in which each interpreter rule corresponds to one tag and defines a message element. If the tag is a start marker, then the interpreter rule interprets the corresponding simplex constituent. Alternatively, if the tag is a start label, then the interpreter rule interprets the corresponding complex constituent. The interpreter rule operates to construct the message element from the tokens of the corresponding simplex or complex constituent. The resulting message element may be flagged as “optional” text. Alternatively, the message element may be null.

A corresponding tokenized text is created from the structured text. A token created from the structured text corresponds to either a full line of structured text or to a word of structured text delimited by whitespace. The tokenized text includes tokens and simplex constituents constructed in accordance with the predetermined set of tokenizer rules of the token pattern knowledge base. The tokenized text is preferably created by comparing the structured text to the token patterns in the token pattern knowledge base.

A corresponding parsed text is created from the tokenized text. The parsed text includes the tokenized text and any complex constituents constructed in accordance with the predetermined set of parser rules of the parser rule knowledge base. Each parser rule defines a sequence of complex constituents input elements of at least one token and/or simplex constituent and/or complex constituent that must be matched in order for the corresponding complex constituent to be created. A parser rule may preferably be constrained and/or have probabilistically specified elements. When the sequence of complex constituent input elements is matched, the corresponding complex constituent is added to the parsed text.

A corresponding processed text is created from the parsed text. The processed text includes message elements constructed in accordance with the predetermined set of interpreter rules of the interpretation knowledge base. A tree structure including a root node, internal nodes, and leaves is created from the tokens, simplex constituents, and complex constituents of the parsed text. The root node dominates the internal nodes and leaves, the root node and each of the internal nodes in the tree have corresponding interpretation functions, and the leaves are tokens of the parsed text. The interpretation functions associated with the root node and each internal node may preferably include a default function. The default function may preferably include concatenation of the tokens of the constituent. A user-specified function for producing the message element corresponding to a constituent may also be provided. Traversal of the tree structure results in the identification and interpretation of the message elements of the corresponding parsed text. Message elements may be flagged by the interpreter, according to the predetermined interpreter rules in the interpreter knowledge base, for optional post-processing. Additionally, an output may preferably include tags that are interpreted by a text-to-speech system.

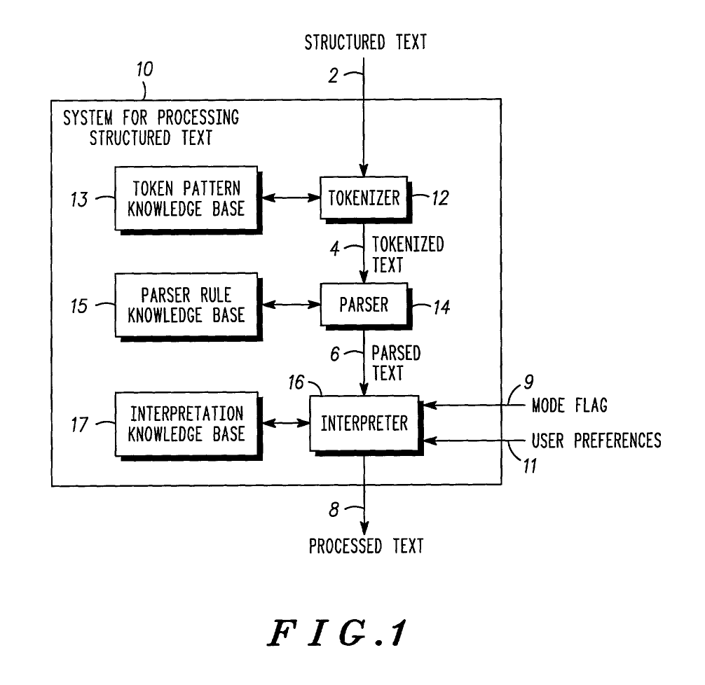

FIG. 1 illustrates a preferred embodiment of a system 10 for processing structured text. Structured text may preferably be any text that is characterized by the same set of regular patterns such as, for example, e-mail messages and weather reports. The processed text may then be converted to speech by a conventional TTS (Text-to-Speech) synthesizer or a TTS synthesizer that accepts tagged text. The system 10 includes three steps, namely, a tokenization step, a parsing step, and an interpreting step. In the tokenization step, a tokenizer constructs tokenized text from the structured text and adds token-level SGML (Standard Generalized Markup Language) markup to the tokenized text to encode simplex constituents according to a predetermined set of rules. This is preferably accomplished by adding a pair of tags, namely a start marker and an end marker, to the tokenized text. In the parsing step, a parser applies additional SGML markup to the tokenized text to encode complex constituents according to another predetermined set of rules, to result in a parsed text. In the interpreting step, an interpreter interprets the parsed text to encode message elements according to yet another predetermined set of rules and according to the specific type of TTS engine, to result in a processed text.

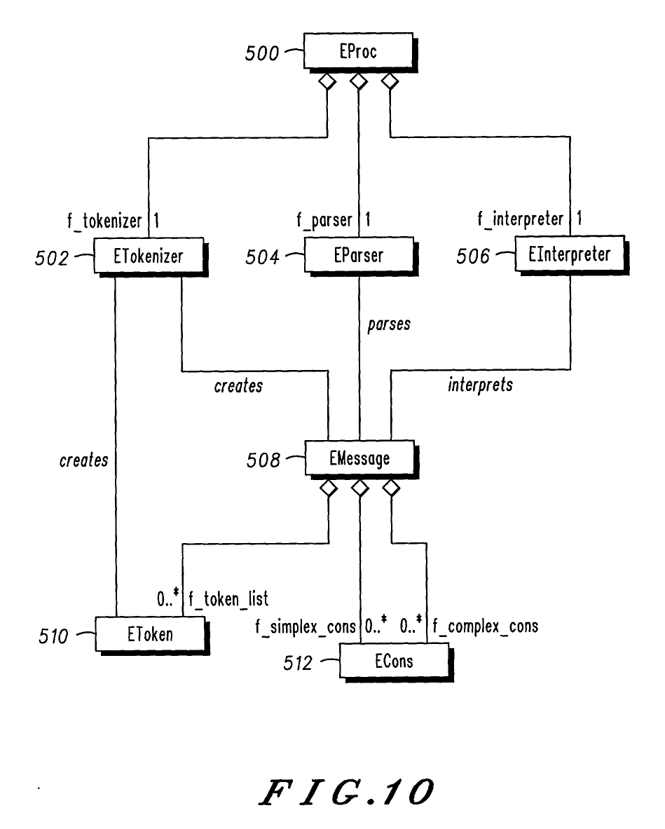

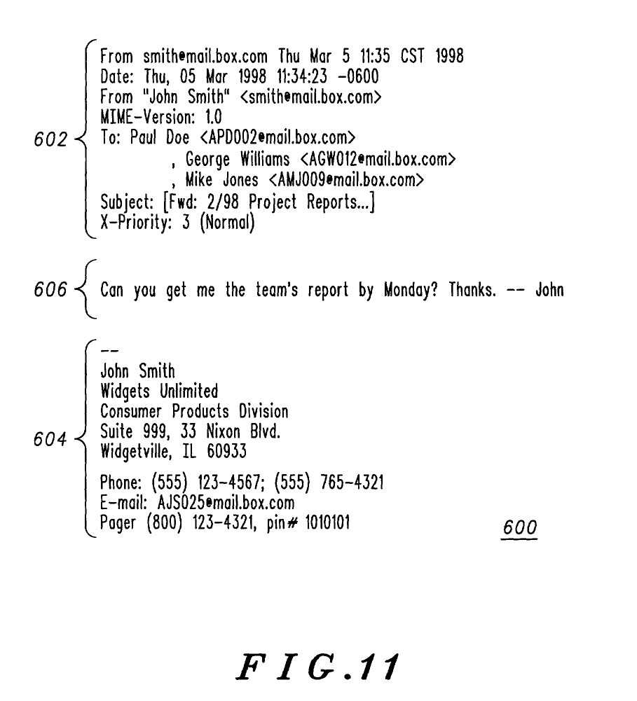

As shown in FIG. 1, the system 10 generally includes a tokenizer 12, a parser 14, and an interpreter 16. The tokenizer 12 may receive raw structured text 2 such as, for example, an e-mail message 600 (see FIG. 11). The structured text may be comprised of a sequence of words that are arranged in lines of text. The tokenizer 12 creates tokenized text 4 from the structured text by creating tokens. A token is a data structure or software object that includes a string of text, a list of start tags, and a list of end tags. The list of start tags and the list of end tags each may be empty depending upon the particular application. The string of text may be either an entire line of text in a file or at least one word that is delimited by whitespace in the file. A sequence of one or more tokens may be identified by the tokenizer 12 as a simplex constituent. A simplex constituent is a software object that references (i.e. spans) a sequence of one or more tokens. A simplex constituent includes a reference to the first token in the sequence, includes a reference to the last token in the sequence, and includes a tag indicating the type of simplex constituent. For a sequence of tokens identified as a simplex constituent, a start marker is added to a start tag list of the first token and an end marker is added to an end tag list of the last token.

As shown in FIG. 1, a token pattern knowledge base 13 is provided. The tokenizer 12 adds token-level SGML markup including start marker and end markers to the tokenized text according to a predetermined set of tokenizer rules set forth in the token pattern knowledge base 13. As a result, the tokenized text that is output by the tokenizer 12 will include tokens preferentially annotated with simplex constituents.

A parser rule knowledge base 15 that includes a predetermined set of parser rules for the parser 14 is provided. The parser 14 applies additional SGML markup including start labels and end labels to the tokenized text received from the tokenizer 12 according to the parser rules set forth in the parser rule knowledge base 15. A sequence of one or more simplex constituents, complex constituents and/or untagged tokens may be identified by the parser 14 as a complex constituent. The parser 14 identifies complex constituents according to the parser rules included in the parser rule knowledge base 15. The parser 14 may identify and create complex constituents from the tokens and/or the simplex constituents produced during the tokenization process. Alternatively, the parser 14 may identify and create complex constituents from complex constituents produced during the parsing step. The parsing step may also provide a probabilistic approach to identifying structural elements of a message based on the occurrence of predetermined tokens and/or simplex constituents and/or complex constituents within a certain range of lines in a message.

An example of such a probabilistic approach would be the identification of the “signature block” of an e-mail message. Although (unlike the header of an e-mail message) the format of the signature block is not governed by specific rules, it tends to have a fairly conventional form; for example, the address and contact information as shown in FIG. 11, element 604.

Although it is possible to write a grammar of e-mail signature block structure that could be processed by the parser, an alternative approach would be based on the combination of typical “signature” elements (e.g., simplex constituents relating to contact information, address elements, delimiters, etc.) into a signature block if their frequency of occurrence within a specified number of lines exceeded a predetermined threshold. Thus, a concentration of simplex constituents of the type that typically occur in a signature block, particularly towards the end of an e-mail message, would be taken as evidence of the probable existence of a signature block, which could then be generated despite the absence of specific rules defining its structure.

An interpretation knowledge base 17 that includes a predetermined set of interpreter rules for the interpreter 16 is provided. The interpreter 16 uses the interpretation knowledge base 17 to determine how the simplex and complex constituents in the parsed text 6 should be interpreted to produce the message elements in the processed text 8. The interpreter 16 can function in both a PLAIN mode and a TAG mode, as determined by a mode flag 9. If the interpreter 16 is in the PLAIN mode, it will interpret the constituents of the parsed text 6 in order to produce message elements to be pronounced properly by a conventional text-to-speech system. If the interpreter 16 is in the TAG mode, it will preserve the tags by producing a tagged text for a text-to-speech system that accepts tags. The interpreter 16 may preferably be programmed to include various user preferences 11, for example, the identification and inclusion of optional message elements in the processed text 8.

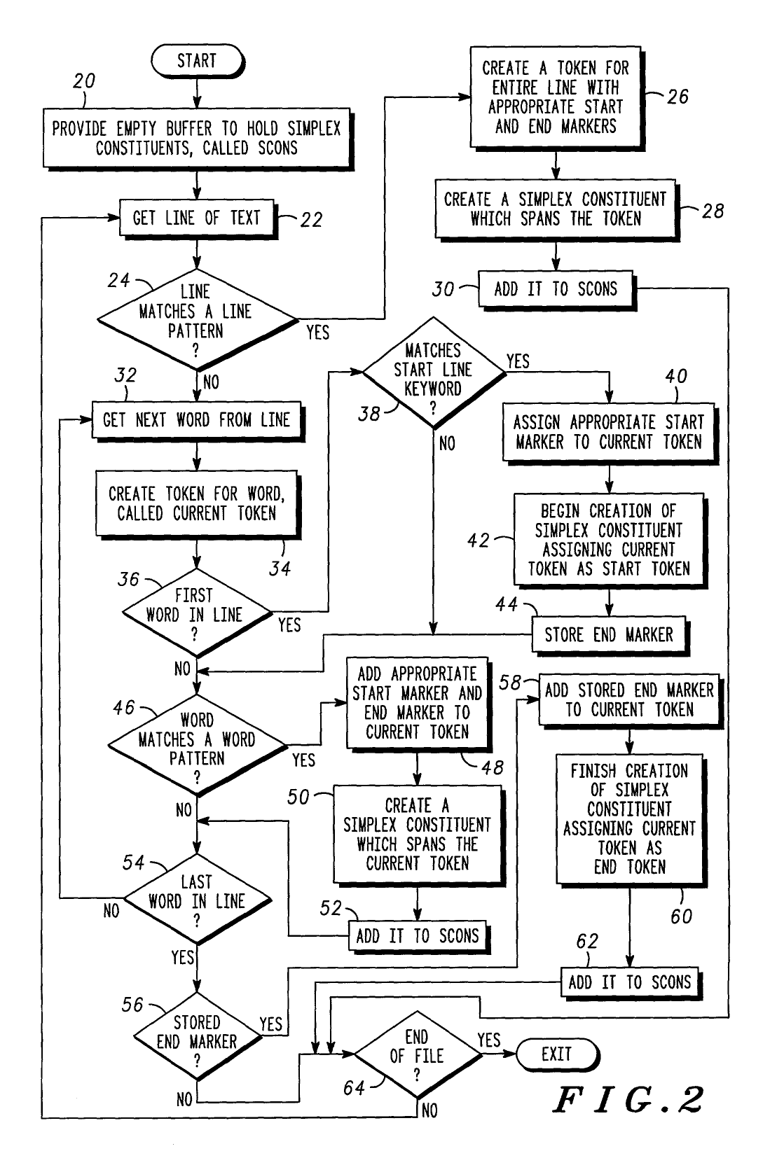

FIG. 2 illustrates one example of the operation of the tokenization step in accordance with one aspect of the invention. The tokenizer 12 provides a simplex constituent buffer called “SCONS” (initially empty) to hold a list of simplex constituents (Block 20). As represented in Block 22, the tokenizer 12 receives a line of structured text. If the line of text matches a line pattern stored in the token pattern knowledge base 13 (Block 24), resulting in a matched line pattern, a line-spanning token is created for the entire line with appropriate start and end markers (Block 26). A full-line token simplex constituent is created which spans the line-spanning token (Block 28). The full-line token simplex constituent is added to SCONS (Block 30).

If the line of text does not match any line pattern stored in the token pattern knowledge base 13 (Block 24), the tokenizer 12 processes the first word from the line (Block 32). A first word token is created for the first word (Block 34). If the first word matches a start line keyword stored in the token pattern knowledge base 13 (Blocks 36 and 38), resulting in a matched start line keyword, an appropriate start marker is assigned to the token for the first word (Block 40). Block 42 represents the beginning of the creation of a full-line simplex constituent wherein the token for the first word is assigned as the start token. A stored end marker is stored in memory for later use (Block 44). The tokenizer 12 then obtains the next word from the line (Block 32) as a current word and creates a current token corresponding to the current word (Block 34). If the current word matches a word pattern stored in the token pattern knowledge base 13 (Block 46), resulting in a matched word pattern, then the corresponding start marker and end marker are applied to the current token (Block 48). Block 50 represents the creation of a single-word simplex constituent that spans the current token. The single-word simplex constituent is then added to SCONS (Block 52). If the current word is not the last word in the line (Block 54), then Blocks 32 through 54 are repeated until the last word in the line has been processed.

If the current word is the last word in the line (Block 54) and the stored end marker is not null (Block 56), the stored end marker is added to the current token (Block 58). Block 60 represents the completion of the creation of the full-line simplex constituent in which the current token is assigned as the end token of the full-line simplex constituent. The full-line simplex constituent is then added to SCONS (Block 62). The tokenizer repeats the process described above for each line of structured text until the end of the file (Block 64).

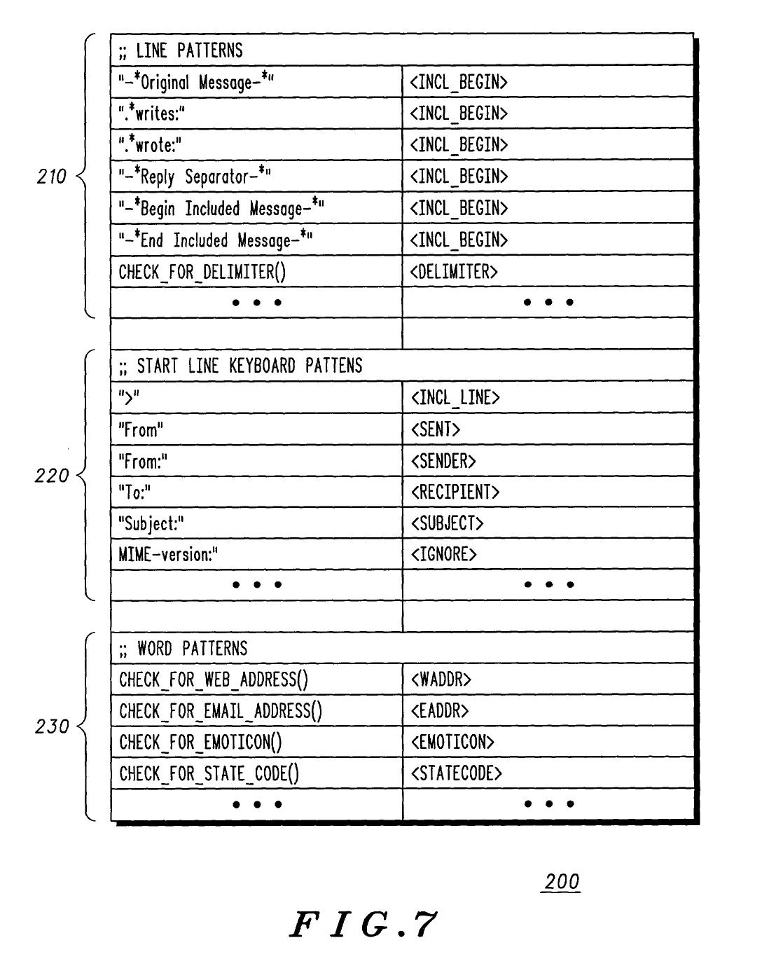

FIG. 7 illustrates an example of the token pattern knowledge base 13 (see FIG. 1) implemented as a token pattern table 200. The top section 210 of the table sets forth various line patterns, the middle section 220 of the table sets forth the various start line keyword patterns, and the bottom section 230 of the table sets forth the various word patterns. The token pattern table 200 can be altered to enable the tokenizer 12 to identify any well-defined pattern of structured text within a particular line of text. This results in a highly flexible tokenization process.

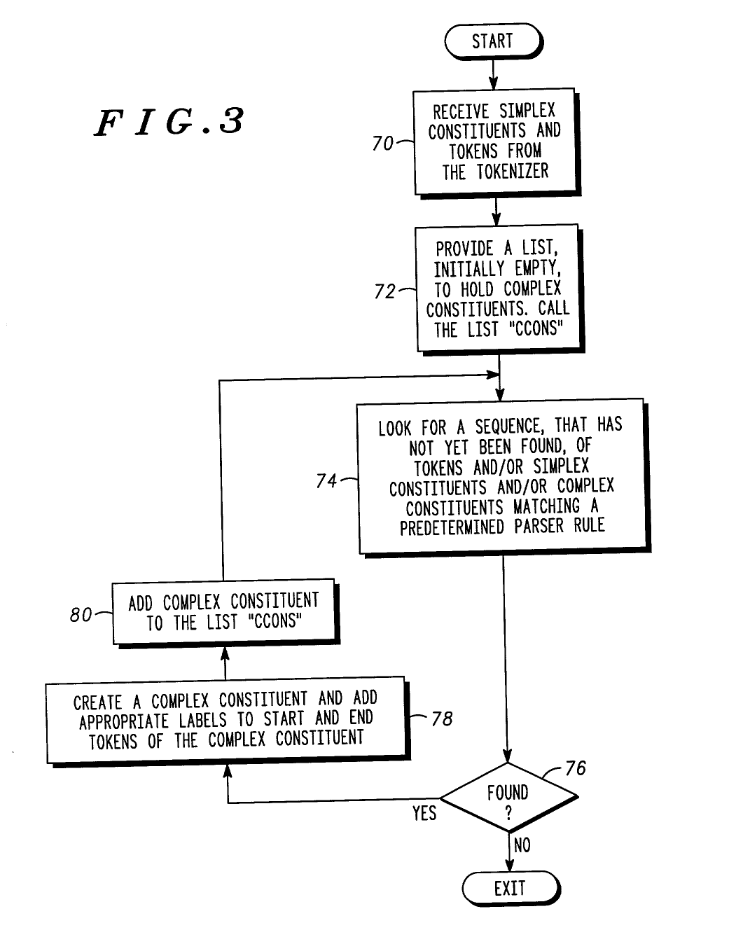

FIG. 3 illustrates one example of the operation of the parsing step in accordance with the present invention. As represented in Block 70, the parser 14 receives simplex constituents and tokens from the tokenizer 12. The parser 14 provides a complex constituent buffer called “CCONS” (initially empty) to hold a list of complex constituents (Block 72). The parser 14 searches for a sequence (that has not yet been found) of complex constituent input elements, i.e., tokens and/or simplex constituents and/or complex constituents, that matches a predetermined parsing rule included in the parser rule knowledge base 15 (Block 74), resulting in a matched complex constituent input sequence. If the sequence is found (Block 76), a complex constituent is created and appropriate start and end labels are applied to the start and end tokens of the complex constituent (Block 78). The complex constituent is then added to CCONS (Block 80). This process is completed when all of the complex constituents are created, resulting in a parsed text. The flowchart diagram of FIG. 3 illustrates, in general, a bottom-up parser. It is known that such parsing could be performed top-down. Also, it is contemplated that the parser performance can use a table that records partial results (i.e., chart parsing), a look-ahead table for rule selection, rule selection heuristics, or rule filtering.

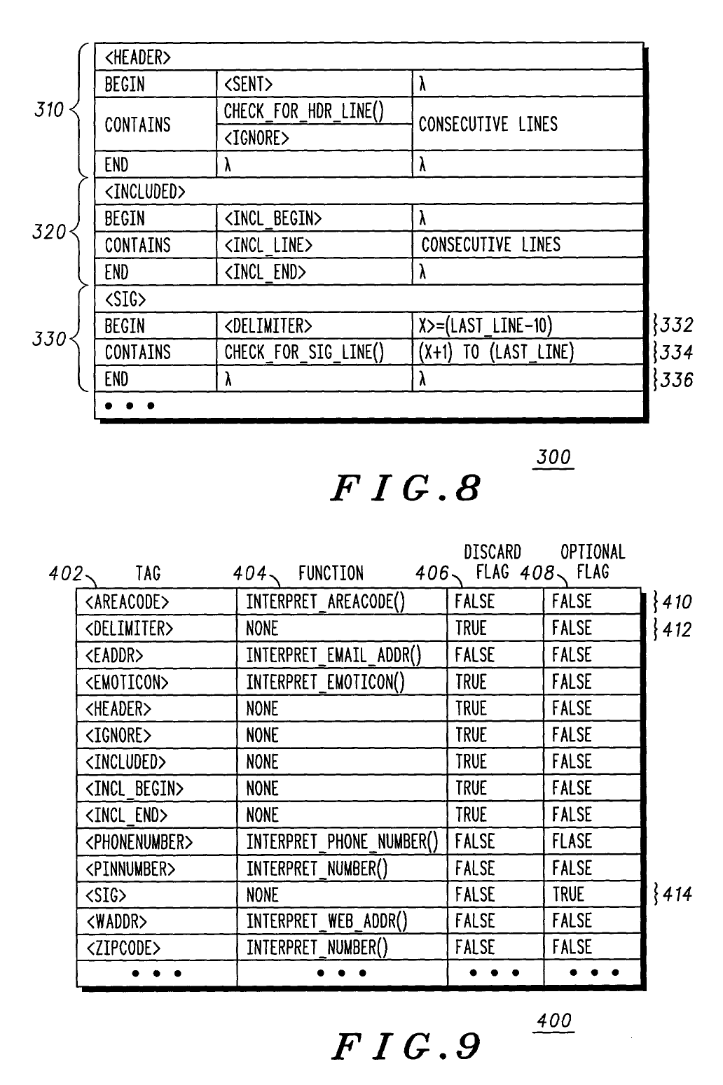

FIG. 8 illustrates an example of the parser rule knowledge base 15 (see FIG. 1) implemented as a parser table 300. Each parser rule in FIG. 8 is encoded as a block including the complex constituent label (e.g., <HEADER>, <INCLUDED>, etc.) on a single line, followed by three predicate fields, each having at least one line, labeled “BEGIN”, “CONTAINS”, and “END”, as shown in the figure. For a parser rule to be satisfied (thus resulting in the construction of a complex constituent), all three predicates must be true (the entry “λ” in the table indicates that the corresponding predicate is automatically true) when the rule is applied to a sequence of complex constituent input elements. Each of the three predicate fields includes at least one two-part subrule specification, as shown in the figure. The first part of the subrule specification typically includes a constituent tag or a function that must be satisfied by the predicate (i.e., by the tag being present in the sequence or the function returning “true” after being applied to the sequence), while the second part of the subrule specification includes an optional restriction on the subrule.

For example, the BEGIN predicate 332 of the <SIG> parser rule is satisfied if a <DELIMITER> constituent occurs on the Xth line of the file, where X is 10 or fewer lines from the end of the file. Once the BEGIN predicate has been satisfied, the CONTAINS predicate 334 will be satisfied if the CHECK_FOR_SIG_LINE( ) function returns “true” after being applied to the lines from the (X+1)th line to the last line of the file. Because the END predicate 336 is automatically “true” as shown, if the BEGIN and CONTAINS predicate are satisfied as described above, a <SIG> constituent is constructed spanning the corresponding tokens.

As with the token pattern table 200, the parser table 300 can be altered. For example, if it is determined that the delimiter for a <SIG> constituent should be optional, this can be reflected in the parser table by modifying the BEGIN predicate accordingly. Similarly, tests for the CONTAINS predicate can be modified in the CHECK_FOR_SIG_LINE( ) function in order to alter the result returned by this function. This enables the parser 14 to identify any structurally specified element of a message based on occurrences of predetermined tokens, simplex constituents, and/or complex constituents optionally within a certain range of lines in the file. This results in a highly flexible parsing process.

Alternatively, parser rules can also be of the form of context-free rules as is generally known in the parser art, such as phrase structure rules. Parsing based on rules implemented as networks including ATN's (augmented transition networks) or RTN's (recursive transition networks) could also be done.

An advantage of the present invention is that, by having a two-stage process to identify constituents (i.e. tokenization followed by parsing), the tokenizer 12 can conditionally identify constituents based on the context in which they occur, deferring the final decision to be performed by the parser 14. In a preferred embodiment, the parser 14 can simply change the tag of a constituent based upon further contextual analysis. For example, the tokenizer 12 may assign the sequence of digits “60173” to <ZIPCODE>, but in the second stage the parser 14 may account for the context of “my pin is 60173” and change the tag to <PINNUMBER>. The output of the tokenizer 12 may be: “my pin is <ZIPCODE>60173</ZIPCODE>” and then the parser 14 may produce “my pin is <PINNUMBER>60173</PINNUMBER>.”

Alternatively, the tokenizer 12 may assign a general tag to a constituent, which then could be specialized to a more specific tag by the parser 14. For example, the tokenizer 12 might assign the sequence of digits “60173” to <NUMBER>, but in the second stage the parser 14 might account for the context of “my pin is 60173” and add the tag <PINNUMBER>. The output of the tokenizer 12 may be: “my pin is <NUMBER>60173</NUMBER” and the parser 14 may produce: “my pin is <NUMBER><PINNUMBER>60173</PINNUMBER></NUMBER>.”

Alternatively, given the sequence of digits “60173,” the tokenizer 12 may assign all alternative tags in a disjunctive tag specification and then the parser 14 would select the most likely correct tag from the alternatives. For example, the tokenizer 12 may assign the sequence of digits “60173” to “<ZIPCODE> or <PINNUMBER>” and the parser 14 may then be able to select the correct tag based on context. The output of the tokenizer 12 may be: “my pin is {<ZIPCODE> or <PINNUMBER>}60173{</ZIPCODE> or </PINNUMBER>} and the parser 14 may produce: “my pin is <PINNUMBER>60173</PINNUMBER>.” Note that the choice of a specific start tag alternative in a disjunctive tag specification must be accompanied by choosing the correct corresponding end tag. This is accomplished by referencing disjunctive tag specifications through their corresponding constituent, thus ensuring that the start and end tags cannot vary independently.

FIG. 4 illustrates one example of the operation of the interpreting step in accordance with the present invention. The interpreter 16 receives parsed text including tokens, simplex constituents, and complex constituents from the parser 14 (Block 90). The interpreter 16 creates a constituent that spans all of the tokens, simplex constituents, and complex constituents, called <MESSAGE> (Block 92). All of the tokens, simplex constituents, and complex constituents are arranged into a tree where the root node and each internal node includes a tag identifying a constituent and a string buffer for its corresponding message element (possibly null), leaf nodes are tokens, and the constituent included in the root node is the <MESSAGE> (Block 94).

FIG. 5 illustrates a message 120 expressed as a tree. The root node is <MESSAGE> (Block 122). Children of the <MESSAGE> node include, for example, the <HEADER> node (Block 124) and the <SIG> node (Block 126). Leaf nodes include, for example, the token “Can” (Block 128) and the token “you” (Block 130). The <SENT> node (Block 132) and the <DATE> node (Block 134) are children of the <HEADER> node. The <EADDR> node (Block 138) is a child of the <SENT> node. Other leaf nodes include “From” (Block 136), “Thu” (Block 140), “1998” (Block 144) and “smith@mail.box.com” (Block 146).

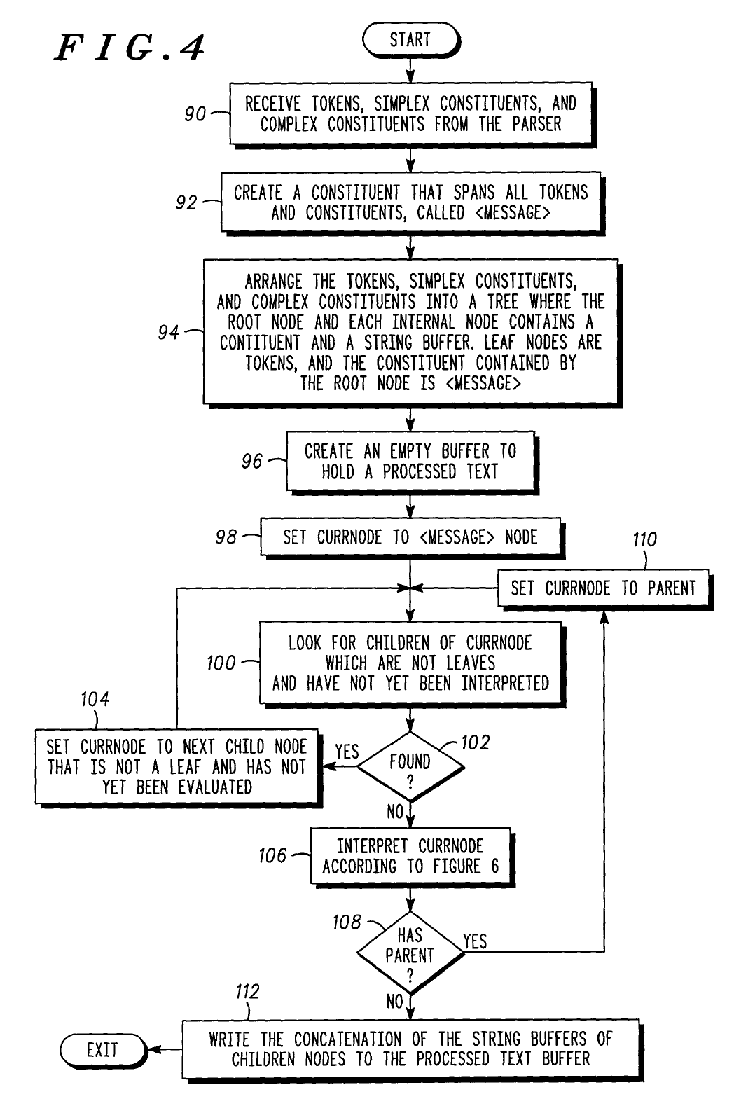

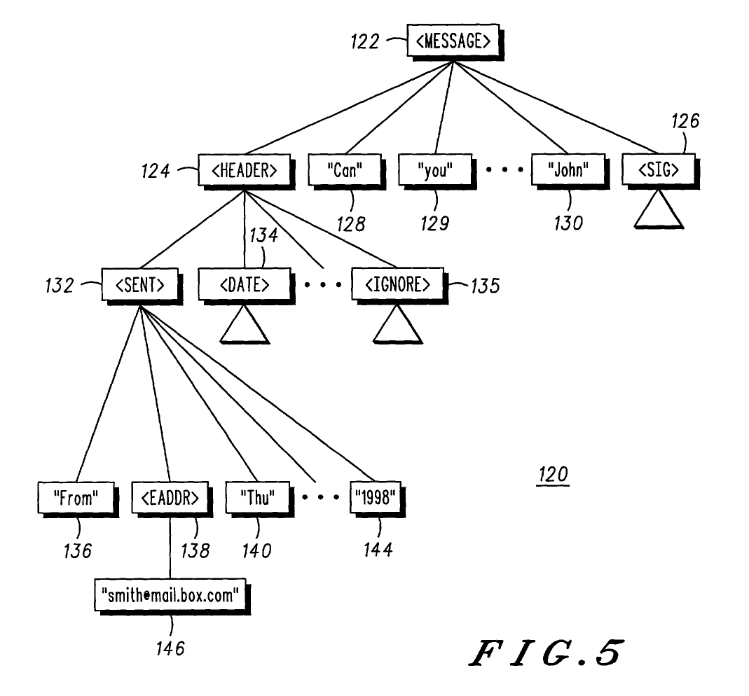

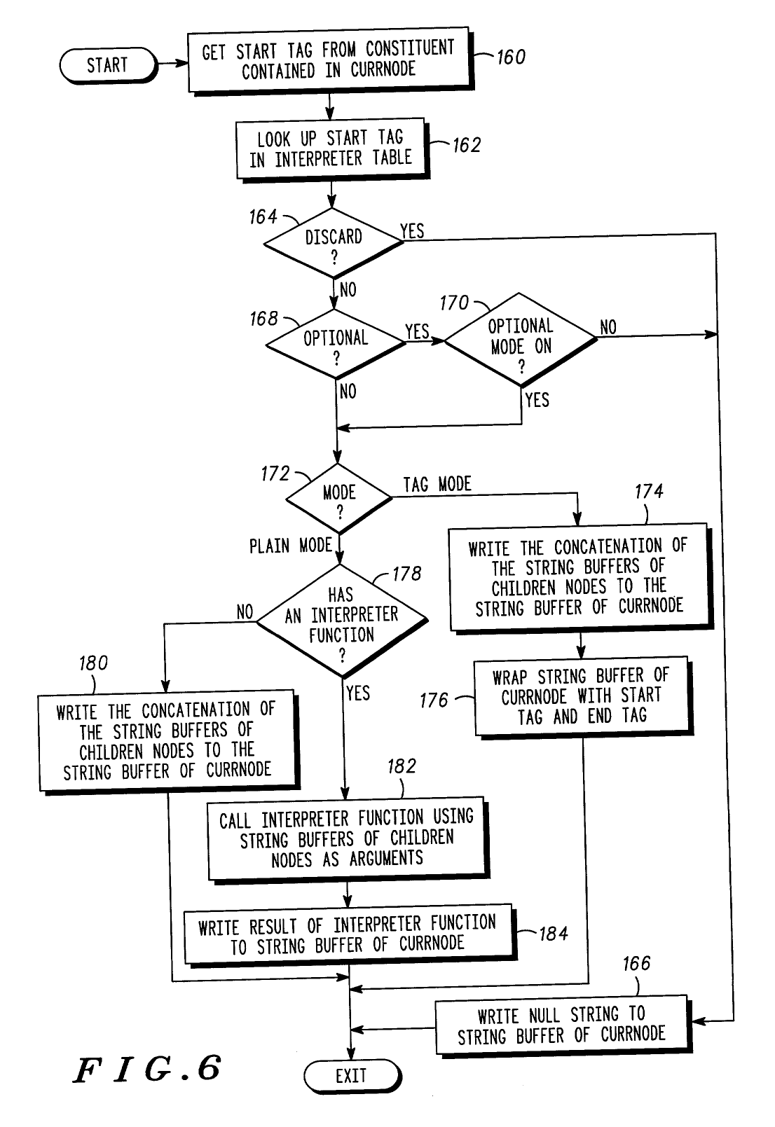

Referring again to FIG. 4, the interpreter 16 creates an empty buffer to hold a processed text including message elements (Block 96). The current node is set to the <MESSAGE> node (Block 98). The interpreter 16 looks for children of the current node which are not leaves and have not yet been interpreted (Block 100). If the children are found (Block 102), the interpreter 16 sets the current node to the next child node that is not a leaf and has not yet been evaluated (Block 104). The interpreter 16 then continues to look for children of the current node which are not leaves and have not yet been interpreted (Block 100). If no children are found (Block 102), then the interpreter 16 interprets the current node according to FIG. 6 (Block 106).

FIG. 6 illustrates one example of the operation of the interpretation of a single node. The interpreter 16 first receives the start tag from the constituent included in the current node (Block 160). The interpreter 16 will then look up the start tag in the interpretation knowledge base 17 (Block 162). If the interpretation knowledge base 17 indicates that the constituent should be discarded (Block 164), then the interpreter 16 will write a null string to the string buffer of the current node (Block 166). Similarly, if the interpretation knowledge base 17 indicates that the constituent should not be discarded (Block 164), and if the interpretation knowledge base 17 indicates that the constituent is optional (Block 168), and the optional mode of the interpreter 16 is off (Block 170), then the interpreter 16 will write a null string to the string buffer of the current node (Block 166). If the interpretation knowledge base 17 indicates that the constituent should not be discarded (Block 164), and if the interpretation knowledge base 17 indicates that the constituent is not optional (Block 168), and the interpreter 16 is in the TAG mode (Block 172), then the interpreter 16 will write the concatenation of the contents of the string buffers of the children nodes to the string buffer of the current node (Block 174). The interpreter 16 then wraps the contents of the string buffer of the current node with a start tag and an end tag (Block 176). If the interpreter 16 is in the PLAIN mode (Block 172) and the start tag has no interpreter function (Block 178), then the interpreter 16 will perform a default interpreter function by preferably writing the concatenation of the contents of the string buffers of the children nodes to the string buffer of the current node (Block 180). If the start tag has an interpreter function (Block 178), the interpreter 16 calls the interpreter function using the contents of the string buffers of the children nodes as arguments (Block 182). The interpreter 16 then writes the results of the interpreter function to the string buffer of the current node (Block 184).

FIG. 9 illustrates an example of the interpretation knowledge base 17 (FIG. 1) implemented as an interpreter table 400. The first column 402 of the interpreter table includes the tag of the constituent to be interpreted. The second column 404 of the interpreter table includes the name of the interpreter function to be used (“NONE” in this column indicates that the default function will be used). The third column 406 of the interpreter table includes the value of the “discard” flag. Finally, the fourth column 408 of the interpreter table includes the value of the “optional” flag.

For example, the first line 410 of the table defines the interpretation of the <AREA CODE> constituent using the INTERPRET_AREACODE( ) function, and indicates that the text associated with the constituent is not optional and is not to be discarded when the interpreter is operating in PLAIN mode. Similarly, the second line 412 of the table defines the interpretation of the <DELIMITER> constituent using the default function (because no user-specified function is supplied), and indicates that the text associated with the constituent is not optional and is to be discarded when the interpreter is operating in PLAIN mode. Finally, the twelfth line 414 of the table defines the interpretation of the <SIG> (“signature”) constituent using the default function, and indicates that the text associated with the constituent is optional and is not to be discarded when the interpreter is operating in PLAIN mode.

As with the token pattern table 200 and the parser table 300, the interpreter table 400 can be altered. For example, if it is desired that emoticons be represented in the output in PLAIN mode, the “discard” entry in the table would be changed from “TRUE” to “FALSE” as a user-supplied function (e.g., INTERPRET_EMOTICON( ), which could, for example, convert the emoticon “:-)” to a pronounceable text string such as “smiley”) would be provided. This enables the interpreter 16 to construct the message element corresponding to any simplex constituent and/or complex constituent in the parsed text and determine whether the message element should be included in the processed text. This results in a highly flexible interpreting process.

Referring again to FIG. 4, once the current node has been interpreted (Block 106), the interpreter 16 checks whether the current node that was interpreted has a parent (Block 108). If it does, then the current node is set to the parent (Block 110) and steps set forth in Blocks 100, 102, 104, 106 and 108 are repeated until the end of the message. After all of the parent nodes are interpreted, the interpreter 16 writes the concatenation of the included strings of the children nodes and stores the processed message in the buffer (Block 112).

FIG. 10 is a Unified Modeling Language (UML) diagram for an embodiment of the system 10 shown generally in FIG. 1. In particular, as shown in FIG. 10, the system for processing structured text, e.g., e-mail messages may preferably include seven classes:

1. The EProc class 500 controls the processing of e-mail messages. Each EProc object includes an ETokenizer, EParser, and EInterpreter object. The EProc 500 processes the text of an e-mail message by: (a) calling the ETokenizer's Tokenize function to construct and return the corresponding EMessage object; (b) calling the EParser's Parse function to parse the EMessage, and (c) calling the EInterpreter's Interpret function to interpret the Emessage (thus resulting in text that is passed on to the TTS system to be pronounced). Each of these functions is described in further detail below.

2. The ETokenizer class 502 creates an EMessage object from the text of the e-mail message by tokenizing the text into ETokens to which it then applies token-level SGML markup. Segmentation is preferably based on whitespace, with no reanalysis of tokenization decisions based on subsequent processing (other than the optional modification of tags a discussed above regarding FIG. 8).

3. The EParser class 504 applies additional SGML markup to the ETokens included in the EMessage. The encapsulation of the tokenization and parsing steps in two different classes reduces the complexity of the overall system by separating concatenative from hierarchical processes.

4. The EInterpreter class 506 generates the text of the e-mail message from the parsed message, edited according to the requirements of a particular TTS system. For example, e-mail headers can be filtered out of the message by specifying the deletion of tokens marked-up with a HEADER tag.

5. The EMessage class 508 includes the text of an e-mail message including ETokens. It also encapsulates the hierarchical structure of the e-mail message encoded by use of the ECons class (as discussed below).

6. The EToken class 510 encapsulates the tokens of the e-mail message, to which SGML markup can be applied. As can be seen in FIG. 10, an instance of the EToken class 510 may include a substantial amount of data and functionality (thus simplifying the classes that use it).

7. The ECons class 512 encapsulates the constituents used in parsing the e-mail message. Each ECons object includes: (a) a constituent tag, and (b) the indexes of the starting and ending points of the span of ETokens in the text that it dominates.

FIGS. 11-14 illustrate trace listings generated by the system during its processing of structured text such as an e-mail message. In particular, FIG. 11 illustrates an example of the text of an e-mail message 600 as it is received by the ETokenizer class. This particular e-mail message 600 includes several header lines 602 which preferably should not be pronounced by the TTS system, as well as a signature block 604 that may be identified for special processing (e.g. optional pronunciation, as discussed below). The actual message to be extracted is the single line of text 606 at line 15 in the e-mail message 600.

FIG. 12B illustrates a trace of the parse 700 generated by the EParser 504 after it receives the tokenized text of the e-mail message (illustrated in FIG. 12A) from the ETokenizer 502. The list of simplex constituents 702 corresponds to the token-level markup applied by the ETokenizer 502, while the list of complex constituents 704 is generated by the EParser 504 based on its analysis of the tokenized text. As shown in FIG. 12B, 23 simplex constituents are identified in this particular e-mail message. There are three different types of simplex constituents, which may be characterized as follows:

1. Header elements (e.g. SENT 706, DATE 708, SENDER 710, RECIPIENT 712, SUBJECT 714). The syntax of e-mail messages includes certain lines that may be reliably identified by their format; e.g., the set of lines prefixed by keywords such as “From” 716, “To:” 718, “Subject:” 720 combine to form the header of an e-mail message. These lines are identified by the ETokenizer 502 (although their actual combination into the header of the e-mail message is done by the EParser 504, with the interpretation of the header deferred to the EInterpreter 506 as described below.)

2. Internally identifiable text (e.g., EADDR 722, IGNORE 724). Certain tokens (e.g., e-mail and web addresses) have a specific internal syntax that may be recognized by the ETokenizer 502 independently of the context in which these tokens occur. This internal syntax is identified by the ETokenizer 502, which assigns tags to these tokens so that they are readily identifiable for later processing (i.e., by the EParser 504 and EInterpreter 506).

3. Contextually identifiable text (e.g., DELIMTER 726, STATECODE 728, ZIPCODE 729, AREACODE 730, PHONENUMBER 732, PINNUMBER 734). Besides the internally identifiable text tokens, a larger (and more loosely defined) class of tokens may be characterized as “contextually identifiable.” For example, a string of five digits with no embedded commas or hyphens (e.g. 60193) may be provisionally identified as a ZIP code by the ETokenizer 502 and tagged as such, deferring the actual interpretation (e.g., pronunciation of each digit in isolation, i.e., “six oh one nine three,” rather than as a five-digit number; i.e., “sixty thousand, one hundred and ninety three”) to the EInterpreter 506 (which will be able to determine, from context, whether or not interpretation as a ZIP code is appropriate).

Two complex constituents are identified in this message; the message's header 750 (dominating simplex constituents S[0] through S[11]) and signature block 752 (dominating simplex constituents S[12] through S[22]), (the EParser 504 scans the simplex constituent table from its last element to its first element, hence the SIG constituent is identified before the HEADER constituent). As was the case for the ETokenizer 502, the EParser 504 identifies elements of the e-mail message but does not interpret them, all interpretation is done by the EInterpreter class 506.

Although the EProc class 500, at present, does not do any further processing of the e-mail message other than the processing required for extracting the portions to be pronounced by the TTS system, any constituent identified by either the ETokenizer 502 or the EParser 504 is potentially available for further processing and EProc accessors can be easily implemented to provide this information to client classes.

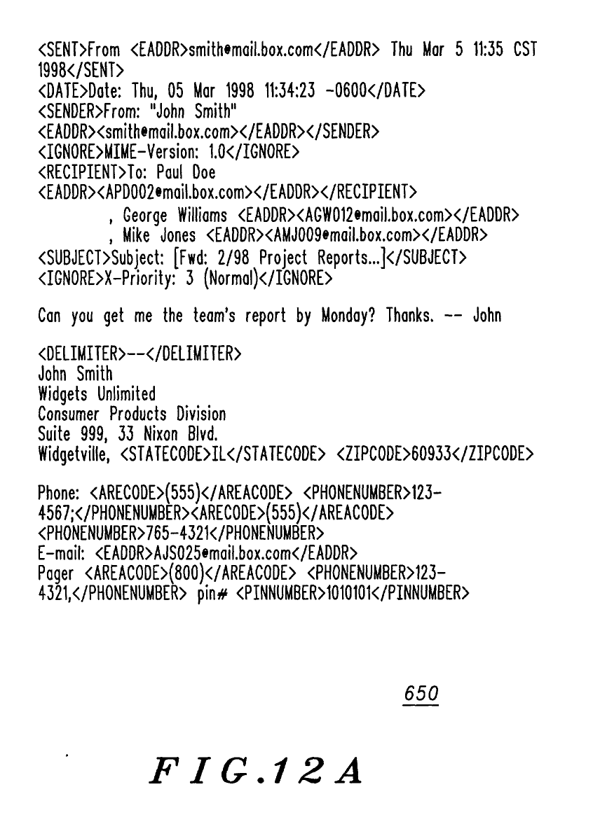

FIG. 13 presents the fully parsed text of the e-mail message (i.e., after it has been processed by the ETokenizer 502 and the EParser 504). As can be seen in FIG. 13, the ETokenizer 502 identifies and tags various components of the e-mail message (e.g. header fields, e-mail and web addresses, etc.). No text has been suppressed at this point (even the keywords directly corresponding to successful tokenizer matches (e.g., line-initial “From”)). The parsed text as shown is what is submitted to the EInterpreter 506 to be interpreted for output. If the EInterpreter 506 is running in TAG mode, it will remove any text identified as being header material (i.e., bracketed by the start label “<HEADER>” and the corresponding end label “</HEADER>”) and pass the remainder of the file to a TTS system, which will be able to recognize and specially process all SGML tags generated by EProc (alternatively, EProc can be run in “PLAIN” mode, as discussed below).

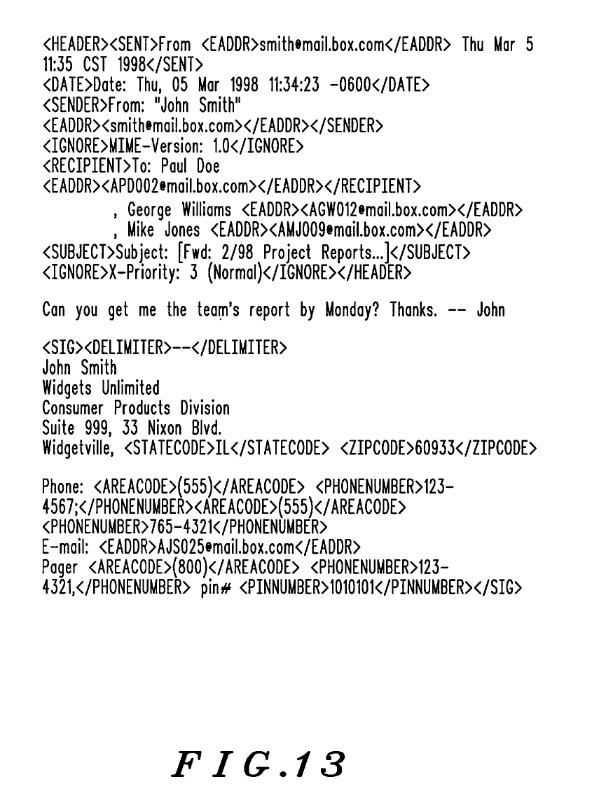

FIGS. 14A and 14B present the output of the interpreting step, as follows. FIG. 14A presents the plain text of the message after it has been processed by the EInterpreter 506 in PLAIN mode. In this mode, the EInterpreter 506 operates under the premise that the TTS system to which it is passing the text cannot recognize markup tags, thus all markup must be interpreted. In FIG. 14A, the “OPTIONAL” post-processor directives are shown explicitly. In actual operation of the system, the EInterpreter 506 may preferably run with the OPTIONAL post-processor mode set either “on” or “off.” In the former case, the text bracketed by the directives would be included as text to be pronounced by the TTS system, while in the latter case it would be suppressed.

Similarly, FIG. 14B presents the tagged text of the message after it has been processed by the EInterpreter 506 in the TAG mode. In this mode, the EInterpreter 506 operates under the premise that the TTS system to which it is passing the text can recognize markup tags, thus the markup tags are preserved in the text to be interpreted by the TTS system. As in FIG. 14A, the “OPTIONAL” post-processor directives are shown explicitly in FIG. 14B. As noted above, in actual operation of the system, the text bracketed by these directives would be included as text to be pronounced by the TTS system if the OPTIONAL post-processor mode is set to “on”, while it would be suppressed if the OPTIONAL post-processor mode is set to “off”. Thus, the functionality provided the OPTIONAL post-processor mode is independent of the functionality provided by the PLAIN and TAG modes.

One advantage of the system 10 (see FIGS. 1 and 10) is that it is capable of identifying a wide variety of e-mail headers, including a functional specification of their components (e.g., sender, recipient(s), subject, etc.). Another advantage of the system 10 is that it capable of identifying a wide variety of embedded messages (even if recursively embedded), including the proper identification and handling of their headers. It is also capable of identifying a wide variety of special sections of text, such as signature blocks, so that these sections can be processed separately from the body of the e-mail message, as specified by the user. Finally, it is capable of identifying elements peculiar to e-mail (such as, for example, emoticons, special acronyms, etc.) and the special handling of these elements as required by the e-mail context.

Moreover, the system 10 is highly flexible due to the fact that the token pattern knowledge base 13, the parser rule knowledge base 15 and the interpretation knowledge base 17 may be changed in order to add new rules or delete old rules. As a result, the system 10 is flexible enough to identify any element of an e-mail message.

Finally, the system 10 can be adapted to process other types of structured text beside e-mail messages. For example, the system 10 may be used for weather reports, financial transactions, or news reports, web applications, or any other structured text. Finally, the constituents identified by the tokenizer 12 and the parser 14 are potentially available for further off-line processing.

It should be appreciated that the embodiments described above are to be considered in all respects only illustrative and not restrictive. The scope of the invention is indicated by the following claims rather than by the foregoing description. All changes which come within the meaning and range of equivalents of the claims are to be embraced within their scope.

What is claimed is:

1. A method of processing a structured text comprising the steps of:
creating, from the structured text, a tokenizer text including simplex constituents constructed in accordance with a predetermined set of tokenized rules of a token pattern knowledge base, each tokenizer rule defining a simplex constituent;
creating, from the tokenized text, a parsed text including complex constituents constructed in accordance with a predetermined set of parser rules of a parser rule knowledge base, each parser rule defining a complex constituent; and
creating, from the parsed text, a processed text including message elements constructed in accordance with a predetermined set of interpreter rules of an interpretation knowledge base, each interpreter rule defining a message element.

2. The method of claim 1, wherein the processed text identifies and provides an interpretation of the message elements of the structured text for text-to-speech synthesis.

3. The method of claim 1, wherein the step of creating the tokenized text comprises the steps of:
providing a simplex constituent buffer to store the simplex constituents; and
processing a line of text in the structured text, resulting in a line of tokenized text including at least one token, until all lines of text have been processed,
wherein the resulting tokenized text includes the tokens and simplex constituents constructed in accordance with the predetermined tokenizer rules, and
wherein each simplex constituent has a start marker applied to a start token of the simplex constituent and an end marker applied to an end token of the simplex constituent.

4. The method of claim 3, wherein the step of processing the line of text comprises the steps of:
processing the line of text as one token if the line of text matches a line pattern in the token pattern knowledge base, to result in a matched line pattern; and
processing the line of text as at least one word if the line of text fails to match any line pattern in the token pattern knowledge base.

5. The method of claim 4, wherein the step of processing the line of text as one token includes the steps of:
creating a line-spanning token, which includes the line of text, wherein the start marker and the end marker identify the simplex constituent corresponding to the matched line pattern in the token pattern knowledge base;
creating a full-line token simplex constituent which spans the line-spanning token; and
storing the full-line token simplex constituent in the simplex constituent buffer.

6. The method of claim 4, wherein the step of processing the first word token includes the steps of:
creating a current token for each word in the line;
processing a first word token which matches a start line keyword pattern in the token pattern knowledge base, to result in a matched start line keyword, a full-line simplex constituent and a stored end marker;
processing a word which matches a word pattern in the token pattern knowledge base, to result in a matched word pattern; and
finalizing the stored end marker.

7. The method of claim 6, wherein the step of processing the first word token includes the steps of:
assigning the start marker to the current token, wherein the start marker identifies the simplex constituent corresponding to the matched start line keyword in the token pattern knowledge base;
creating the full-line simplex constituent corresponding to the matched start line keyword in the token pattern knowledge base;
adding the current token to the full-line simplex constituent as a start token of the full-line simplex constituent; and
saving the stored end marker, wherein the stored end marker identifies the simplex constituent corresponding to the matching start line keyword in the token pattern knowledge base.

8. The method of claim 6, wherein the step of processing the word includes the steps of:
adding the start marker and the end marker to the current token, wherein the start marker and the end marker identify the simplex constituent corresponding to the matched word pattern in the token pattern knowledge base;
creating a single-word simplex constituent spanning the current token which corresponds to the matched word pattern in the token pattern knowledge base; and
adding the single-word simplex constituent to the simplex constituent buffer.

9. The method of claim 6, wherein the step of processing the word includes the steps of:
adding the stored end marker to the current token;
assigning the current token to the full-line simplex constituent; and
adding the full-line simplex constituent to the simplex constituent buffer.

10. The method of claim 1, wherein the step of creating the parsed text comprises the steps of:
providing a complex constituent buffer to store the complex constituents; and
processing the tokenized text until all possible complex constituents have been created.

11. The method of claim 10, wherein the step of processing the tokenized text comprises the steps of:
searching for a sequence of complex constituent input elements that matches one of the predetermined parser rules in the parser rule knowledge base to result in a matched complex constituent input sequence;
creating the complex constituent corresponding to the matched complex constituent input sequence;
adding a start label to a start token of the complex constituent and an end label to an end token of the complex constituent, wherein the start label and the end label identify the complex constituent corresponding to the matched complex constituent input sequence in the parser rule knowledge base; and
adding the complex constituent to the complex constituent buffer.

12. The method of claim 11, wherein the sequence of complex constituent input elements includes at least one of (a) at least one token; (b) at least one simplex constituent which spans at least one token; and (c) at least one complex constituent which spans at least one token.

13. The method of claim 1, wherein the step of creating the processed text comprises the steps of:
creating, from the parsed text, a tree structure including a root node, at least one internal node and leaves, wherein the root node dominates the internal nodes and leaves, the root node and each of the internal nodes in the tree structure have corresponding interpreter functions, and the leaves are tokens of the parsed text; and
traversing the tree structure wherein the interpreter functions associated with the root node and each internal node are executed to result in the corresponding message element.

14. The method of claim 13, wherein the interpretation function includes a default function.

15. The method of claim 14, wherein the default function includes concatenation.

16. The method of claim 13, further comprising a user-specified function to produce the message element

17. The method of claim 13, further comprising an optional post-processor directive to produce the message element.

18. The method of claim 13, further comprising the step of interpreting tags of an output using a text-to-speech synthesizer, wherein the tags correspond to at least one of (a) the start marker and the end marker in the tokenized text, and (b) the start label and the end label in the parsed text.

19. The method of claim 18, wherein the tags are SGML tags.

20. A program for processing a structured text stored on a computer readable medium comprising:
a computer readable program code for creating a tokenized text, from the structured text, including simplex constituents constructed in accordance with a predetermined set of tokenizer rules of a token pattern knowledge base;
a computer readable program code for creating a parsed text, from the tokenized text, including complex constituents constructed in accordance with a predetermined set of parser rules of a parser rule knowledge base; and
a computer readable program code for creating a processed text, from the parsed text, including message elements constructed in accordance with a predetermined set of interpreter rules of an interpretation knowledge base.
